(19) United States
(12) Patent Application Publication
(10) Pub. No.: US 2015/0310504 A1
(43) Pub. Date: Oct. 29, 2015

(54) Automated Method To Match And Initiate Online Social Influencers

(71) Applicant: Kevin Grant Potter, Rancho Santa Fe, CA (US)

(72) Inventor: Kevin Grant Potter, Rancho Santa Fe, CA (US)

(21) Appl. No.: 14/262,155

(22) Filed: Apr. 25, 2014

(51) Int. Cl. G06Q 30/02; G06Q 50/00

(52) U.S. Cl. CPC G06Q 30/0276; G06Q 30/0269; G06Q 50/01

(57) ABSTRACT

A system and computer implemented method where Advertisers can request that a promotional Message, which can be manually crafted or an Automated Promotional Message from their computer systems, be promoted and distributed to users by Social Influencers in online social networks in a unique and novel manner. Without the need for Advertiser knowledge of, review or approval of the Social Influencers, the automated process receives the Message, determines the appropriate Social Influencers to promote the Message, obtains Social Influencer approval, automatically posts the Message to online social networks on behalf of the Social Influencers and manages the settlement of funds with the Advertiser.

### FIELD OF THE INVENTION

This application has no prior Provisional Application reference.

The present invention relates to a unique process and method whereby Advertisers can automate the crafting, initiation and distribution of sharing their promotional messages by Social Influencers, whom the Advertiser may not know, within online social networks.

### BACKGROUND OF THE INVENTION

Advertisers have traditionally used celebrity endorsements to generate interest in their products and services. With the rise of the internet and digital social networks, celebrities have endorsed Advertiser messages (“Messages”) in these social networks as an additional channel for prospective consumers.

Celebrities are attractive to Advertisers as they are Social Influencers, having a level of influence with others. With the rise of digital social networks, many Social Influencers have arisen by virtue of their “followers” (number of followers, friends or subscribers to a person or entity online) and the leverage of the digital reach of the masses has created an exponential increase in the number of, or potential number, of Social Influencers online.

Social networks are digital tools (for example Twitter, Facebook, Instagram and others) that help capture and share a user's social activities, by linking together, in a centralized manner, friends, family, colleagues, acquaintances, third parties, thought leaders and events associated with a user. Social networks provide users a digital interface to interact with others. By being able to share an Advertisers promotional message in a social network, value is created as users following another user (“Social Influencer”) are potential consumers or customers for Advertisers.

In a social network, a Social Influencer is a user who has been afforded the opportunity by others to receive messages from the user. There are various indicators as to the level of influence of a Social Influencer, including but not limited to, the number of ‘followers’ (alternatively called subscribers, friends or similar expressions with the same intent), the level of engagement with messages from the Social Influencers (for example likes, shares, comments, click actions or similar expressions with the same intent) and the ability to share a message and potentially invoke action from those with whom the Social Influencer is associated. Messages shared by many Social Influencers at or around the same time in social networks are indicators that a Message has a propensity to be shared by followers to other users of a social network (“viral” messages), which are attractive to Advertisers as this extends the potential reach of a Message.

Advertisers currently use various tools to identify celebrities and Social Influencers with whom they can engage, often for a commercial fee, to endorse or share their promotional message. Advertisers, or their traditional agents, first select and then engage Social Influencers. There is no current fully automated method for Advertisers to have promoted Messages distributed to Social Influencers in online social networks with no necessary knowledge, or necessary approval of, who the Social Influencers are by the Advertiser.

Another component is the creation, or “crafting”, of a promotional Message, the intent of which is to show the Advertiser, their product or service in a favorable manner to another party in order to elicit a favorable response. These promotional Messages are traditionally crafted (ie written or drafted) by a person with or without digital aids.

In addition to traditional Message crafting, the Message can potentially be automatically and digitally crafted, or an Automatic Promotional Message (APM). Positive events are often recorded in software platforms, for example a large sale represented by an invoice in an accounting system (for example Quickbooks); or a large sales order received (for example Salesforce); or a positive customer review of customer service (for example call center survey software). These software platforms often include transactional (for example accounting) and client facing systems (for example statistics monitoring and customer relationship management software). APM is the concept of automated software identifying a potentially positive event occurring in a software platform and linking this event to a determined positive promotional messaging template and making this event available as an automated positive promotional Message ready for distribution. For example, if a new entry was being processed as a new item being added to the inventory catalogue database in an accounting system, the system could automatically identify a positive potential Message (for example “our company now has a new product”) and make this available as an APM ready for marketing distribution.

To date, most events online have been human initiated (for example posting a comment or picture to a social network). Devices are increasingly connecting and providing data online (a common current expression, online being to provide connectivity to the “cloud”) without human intervention. Such connected digital devices are both wearable and non-wearable. For example, a wearable device that automatically can track the number of steps a user performs in a period, can also make this information automatically available online. Transactions recorded online directly from devices without human intervention, called Machine Traffic, is expected to increase dramatically. Such data may also be an input as an APM. For example, “a user of our product in zip code 92016 just walked 10,000 steps”.

The invention anticipates an automated process and method where an Advertiser would craft a promotional Message, either being manually crafted or an APM, and share this with potentially millions of online social network users through Social Influencers using a unique process and method. The invention would be an automated software process which accepts the Message, identifies and makes the decision on appropriate Social Influencers to promote the Message, obtain Social Influencer approval, automatically post the Message to online social networks on behalf of the Social Influencer/s and manage the settlement of funds between the Advertiser and the Social Influencer/s. The invention addresses the need from having a Message to it being promoted and shared in online social networks, often at large scale, through Social Influencers without the need for Advertiser decision or approval of who will promote or represent their Message online and then fully automate this process through a novel, non-obvious and automated system and method.

### SUMMARY OF THE INVENTION

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

In one embodiment, the invention comprises a computer implemented method configured to provide a third party (“Advertiser”) who wishes to have a promotional advertisement (“Message”) a means to place a Request to an automated software computer system to distribute the Message through Social Influencers determined by the automated system, to online social networks.

In one embodiment, the input promotional Message can be manually crafted.

In another embodiment, the input promotional Message can arise as an Automated Promotional Message (APM). An APM commences when an event is recorded in a computer system and an Advertiser has deemed this event type, or transaction, to be worthy of promotion. The computer system matches the event or transaction to a promotional template and provides the created Message from the combination of the event with the promotional template as available as an input to the system to automatically distribute through Social Influencers to online social networks.

By way of two examples only and not limited by these examples but to demonstrate the principle only, an APM could be as follows. In the first instance, a positive Message in that the Advertiser has concluded a large sales transaction. The accounting system transaction of the Advertiser wherein the sales invoice was recorded could be matched to a template providing the wording that a positive large sale had occurred combined with the location and value of the sale, and this be provided as an input promotional Message. In the second instance, an Advertisers system may record that their product has achieved certain milestones by a customer, for example a vehicle that has traveled over 100,000 miles. The Advertiser system for recording such transaction could be matched to a template providing the wording that a positive customer experience had occurred combined with the location, miles traveled and make of the vehicle model and this be provided as an input promotional Message.

The input promotional Message, whether manually crafted or made available as an APM, can be input manually through an internet enabled web browser or through an Application Programming Interface to the Application Program to Request the automated computer system to identify and action Social Influencers to share the promotional Message into social online networks.

In one embodiment, the Application Program can receive an input Request to promote a Message and then match the Request to appropriate Social Influencers through a Matching Algorithm. The Matching Algorithm is computer code which has as its objective the maximizing of the promotion value of the Message as determined by the Advertiser. The Advertiser indicates their objective to the Application Program, either for each Message or for all Messages input by the Advertiser.

In one embodiment, the objective of the Advertiser can be to one or more of (i) to maximize the audience who will potentially be reached with the promotional Message; and/or (ii) to maximize the demographic profile match of the promotional Message and the Social Influencer; and/or (iii) maximize the demographic profile of the promotional Message to the users, or followers, of the Social Influencers; and/or (iv) maximize the potential for further engagement or sharing of the promotional sharing by users, or followers, of the Social Influencers; and/or (v) maximize the potential future customers arising from being exposed to the promotional Message; and/or (vi) any other parameters the Advertiser and/or the Application Program determine.

In one embodiment, the Application Program accepts the promotional Message input and the objectives of the Advertiser ((Request Engine) and matches this using computer code (Matching Algorithm) to the most, or potentially the most, suitable Social Influencers to promote the Message to achieve the Advertiser's objectives. This is matched via computer code of the Advertiser's objectives to a computer maintained list of Social Influencers wherein it is recorded the key criteria necessary for the computer system to make a matching calculating of potential Social Influencers. The key criteria in the computer contained list can include, but is not limited to, price they require to promote, the number of followers, the impressions (or followers) per unit of price, demographic information of the Social Influencer, demographic information of a Social Influencers followers, metrics demonstrating the history of engagement (for example, like, replies, retweets, comments, shares, click through etc.) with their followers.

In some embodiments, the Social Influencers pre-register and complete their details with the Application Program using an internet enabled browser and in other embodiments, the Social Influencers, their details and some or all of the key criteria are determined from the information provided by the social networks computers to the Application Program through an Application Programming Interface.

In some embodiments, the Application Program determines the likely best match Social Influencer to promote the Message to achieve the objectives of the Advertiser using the Matching Algorithm. In some embodiments, the Application Program then proceeds to Initiate the Social Influencers as whether they wish to approve promoting the Message to their social networks, without any need to reference, get acknowledgement of, or approval for, this action from the Advertiser.

In some embodiments, the Advertiser may elect to, but is not required to, approve any final matching of Social Influencers by the automated method.

In some embodiments, the Application Program's Matching Algorithm then Initiates the process and digitally contacts the Social Influencers based on the best information contact method available to the Application Program (for example automated email, social network message) and the Social Influences accept or decline participation to promote the Message for which they were matched by the Matching Algorithm.

In some embodiments, the approval or denial by the Social Influencers is manually indicated to the Application Program in the automated method through clicking on a button in an internet browser based application, or other computer recognizable form (for example but not limited to text message or voice approval). In another embodiment, the Social Influencer can elect to automatically approve any Requests to promote a Message to their social networks in the Application Program and herein, if there is match to a Social Influencer who elects to use automatic approval, the Application Program deems that the Social Influencer to have approved their promotion of a Message on behalf of an Advertiser.

In some embodiments, upon the Matching Algorithm identifying the appropriate Social Influencer to promote the Message, and having approval by the Social Influencer to promote the Message, either by Message approval or auto-approval by the Social Influencer, the Application program Actions promotion of the Message and will place (or “post”) the promotional Message to the social network as if it came from, or on behalf of, the Social Influencer in a manner that it is seen by the followers of the Social Influencer.

In some embodiments, the Application Program will Action the posting of the Message into the Social Network for the Social Influencer through an automated method using an Application Programming Interface between the Application Program and the social network or social networks.

In some further embodiments, upon the successful posting of the Message into the social networks for the Social Influencer, or after such period that is determined by the Advertiser, the Application Program will use an automated method to withdraw funds (or other compensation of value so agreed, such as Advertiser product as compensation) so required or deposited previously by the Advertiser and recorded in the Application Program and deposit or transfer digitally funds or value for the benefit of, and in compensation for promoting the Message, to the credit of the Social Influencers.

In some additional embodiments, computer implemented methods of reporting to the Advertiser as to the efficacy and performance of the Social Influencers with regards to the promoted Message with their followers is provided by the Application Program through Advertiser access to a graphical user interface of an internet enabled browser, or by distributing the content displayed by the graphical user interface in the form of a report capable of being interpreted or accessed by an internet browser (including PDF, Portable Document Format, webpage, etc), or by distributing the data in a manner capable of being received by another third party computer system through the provision of an API (Application Programming Interface) from the Application Program, for the purposes of providing the information to a third party computer system for use of performance assessment of the Social Influencers by the Advertiser.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

Briefly but without limiting, the present invention comprises a computer implemented method for a third party Advertiser to place a Request to promote a Message by Social Influencers to a third party automated system and method. This Message can be manually crafted or created as an Automated Promoted Message from events recorded in the computer system used by the Advertiser. The automated method and system can use computer code to determine appropriate Social Influencers to achieve the objectives of the Advertiser and then using an automated method to further complete some or all of the following (i) obtain approval from the Social Influencers for them to promote the Message; (ii) post the Message to the social networks for the Social Influencers (iii) ensure funds or remuneration is settled between the Advertiser and Social Influencers for promoting the Message; (iv) provides reporting to the Advertiser on the efficacy of the Social Influencers in promoting the Message.

### BRIEF DESCRIPTION OF THE DRAWINGS

FIG. 1 shows one example of a method whereby a request by an Advertiser to promote a promotional Message is received and Social Influencers to promote the Message are automatically identified and are initiated in the promotion process, independent or without any necessary role, of the Advertiser.

FIG. 2 illustrates one example of a process that the system uses for the Social Influencer to use the automated system to both promote the Message in the online social networks and the subsequent settlement and payment for such promotion by the Advertiser.

### DETAILED DESCRIPTION OF THE INVENTION

As used herein, the term “computer” refers to a machine, apparatus, mobile phone or device that is capable of accepting and performing logic operations from software code. The term “software”, “software code”, “computer software” or “computer code” refers to any set of instructions operable to cause a computer to perform an operation. Thus, the methods and systems of the present invention may be performed by a computer based on instructions received by computer software.

The claimed subject matter is now described with reference to the drawings and for the purposes of explanation, specific details are set forth in order to provide a thorough understanding of the claimed subject matter. It may be evident, however, that the claimed subject matter may be practiced without these specific details. In other instances, methods and systems are illustrated in block diagram form in order to facilitate describing both a detailed and broad understanding of the claimed subject matter.

The purpose of the claimed subject matter is to use a novel, automated system for an Advertiser to have a promoted Message, either manually crafted or arising from a transaction or event in a computer system used by an Advertiser, to be promoted into online digital social networks by Social Influencers without the Advertiser by necessity having knowledge of, approving of, or being part of the initiation of Social Influencers (beyond provision of the Message) to promote their Message.

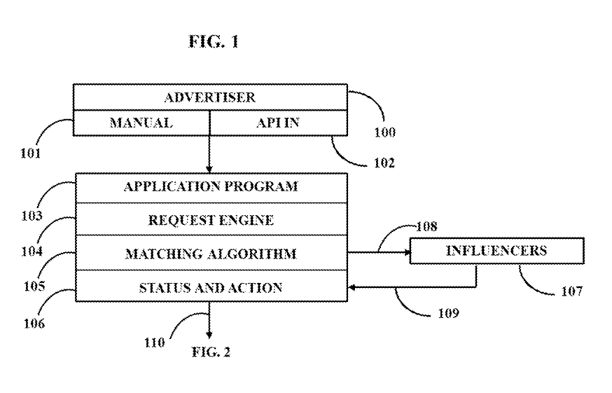

FIG. 1 illustrates one example of a computer implemented method of the present invention. When referring to FIG. 1, the method of an Advertiser creating a Message he wishes to create is shown and to make this available for distribution to the automated method.

The Advertiser has a promotional Message and this they can craft manually or it can be created as an Automated Promotional Message wherein an event recorded in a computer system used by an Advertiser is matched to a promotional template as input to the automated method and process to distribute promotional Messages through Social Influencers to online social networks.

In a broad sense the Advertiser does not necessarily know of, or have necessary relationships, with Social Influencers matched by the Application Program.

By way of a non-limiting example, in FIG. 1, in 100 an Advertiser has a promotional Message they wish to share through Social Influencers into social networks. The Advertiser provides as input to the Application Program in 103, and more specifically to the Application Program's Request Engine in 104, the Message they wish to promote and their promotional objectives with regards the Message.

In FIG. 1, an Advertiser's input information Request can be performed manually as in 101, for example the Advertiser manually entering information into an internet enabled browser of the Application Program and completing a digital form on an electronic interface provided by the system; or can be input electronically as in 102 where the Application Program receives the input Request through an Application Programming Interface with the necessary network authentication token verification. This is illustrated in 102 and the system will transmit into the Application Program identification of the Advertiser, the necessary authentication approvals and the Message to be promoted and if not recorded by the Advertiser prior in the Application Program, the Objectives required when a Message is promoted (for example audience reach, demographic profile of Social Influencers and/or their followers, user engagement) and the fiscal budget for a promotion and associated banking or Advertiser payor details.

In FIG. 1, the Application Program on receiving the input Request from a method using 101 or 102, the Application Program in 103 will authenticate the Advertiser as a user of the system and who is authorized to initiate a promotional Message input 104 to the Request Engine.

In FIG. 1, the Request Engine in 104 will receive the request with the Message to be promoted and determine if the Message meets the requirements of the social networks prevailing at the time (by way of an example, Twitter is a social network that has at the time of writing a 140 character per message limit on Messages) and if the Advertiser has adequate financial credit or deposited the requisite funds to have adequate credit reflected in the Application Program to provide for the Matching Algorithm in 105 to proceed. In one embodiment, the checking of the Messaging matching the requirements of the social networks and the financial standing of the Advertiser is included in 104, and in other embodiments these checks, individually or collectively, can be completed at an earlier stage in the case of 101 or 102 respectively.

In FIG. 1, the example of an approved input promotion Message by the Request Engine in 104 is processed by the Matching Algorithm per 105. The computer code in the Matching Algorithm matches to the most, or potentially the most, suitable Social Influencers to promote the Message to achieve the objectives of the Advertiser.

In FIG. 1, the Message is matched via computer code in 105 with the Objectives of the Advertiser on the one hand; and on the other hand to a computer maintained list in 107 of Social Influencers and their recorded key criteria in order to determine a best fit. The key criteria in the computer contained list can include, but is not limited to, price they require to promote a Message, the number of followers, the impressions (or followers) per unit of price, demographic information of the Social Influencer, demographic information of a Social Influencers followers, metrics demonstrating the history of engagement (for example, like, replies, retweets, comments, shares, number of times a user clicks on part of the message) with their followers. Social Influencers recorded on the list in 107 can have pre-registered with the Application Program or not be registered but whose information is supplied by the social networks through Application Programming Interfaces to the Application Program.

In FIG. 1, the Matching Algorithm upon matching those Social Influencers who are part of 107 that are likely to be the best fit to achieving the objectives of the Advertiser, sends a digital request (for example, an automated email or social network direct message) in 108 to the identified and matched Social Influencers to approve to promote the Message. On receipt, the Social Influencer can elect in 109 to Approve or Decline (or similar denoting terms) to promote the Message. In some embodiments, a Social Influencer can indicate to the Application Program through an internet enabled browser, that they automatically Approve all Message promotion requests and to use the system to automatically return 109 as Approved for all promotion requests made in 108.

Further to FIG. 1, upon an Approve or Deny indicator from a Social Influencer in 109 to promote the Message, the Application Program in 106 determines a Status of the request. Dependent on the Status in 106, the automated system in 110 determines the next actions.

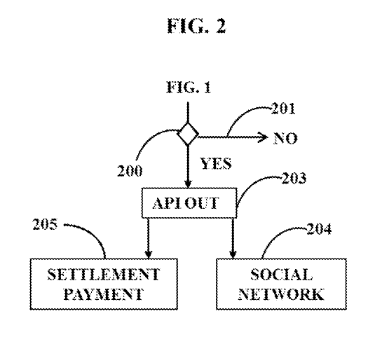

In FIG. 2, the Application Program method determines a decision at 200 dependent on the input from 109. If the Social Influencer declined to promote the Message, the system in 201 does not proceed processing the promotion with that Social Influencer and the process is terminated. In some embodiments, the Application Program places such denied request into the Matching Algorithm (105 of FIG. 1). If the Social Influencer Accepts to promote the message, 200 proceeds with a Yes indicator to 203.

In FIG. 2, the automated process uses Application Programming Interfaces to automatically and programmatically place (“post”) the Message to the social networks in 204 for, or on behalf of, the Social Influencers to be viewable by the Social Influencers followers and to then to use the Application Programming Interface to make payment, or credit, the Social Influencer as compensation from credit or funds held for an on behalf of the Advertiser in 205.

In some embodiments, the processes in Figure's 1 and 2 are all electronic processes, transmission, storage and processing that can be in the form of internet cloud computing through an internet accessible medium, or machine to machine direct interface or a computer system that requires human interface combined with a system, for example email functions.

In some embodiments, the Application Programming Interface in component 102 in FIG. 1 and component 203 in FIG. 2 will use automated software code and processes to retrieve, post and transmit information from the Advertiser's systems, the Application Program and the social networks identified and approved by the Social Influencers in 109 of FIG. 2. This will be done electronically by system machine interfaces and protocols by means of an API in combination with the Advertiser and Social Influencer Credentials stored in the system for access to the identified social network accounts in component 204 in FIG. 2.

The system provides an Advertiser the ability to receive a report via a graphical user interface of an internet enabled browser, or through an Application Programming Interface, for the results arising from components 200, 204 and 205 of FIG. 2.

Although the subject matter has been described in language specific to specific features and or examples, it is understood that the subject matter defined in the appended claims is not necessarily limited to the specific features, acts or illustrative examples. Rather, the specific features and acts described are disclosed as example forms of implementing the claims.

Also, although the disclosure has been shown and described with respect to one or more implementations, equivalent alterations and modifications will occur to others skilled in the art based upon a reading and understanding of this specification and the annexed drawings. In particular regard to the various functions performed by the above described components (e.g., Application Program, Application Programming Interface, API, API In, API Out, Request Engine, Matching Algorithm, Graphical User Interface etc.), the terms used to describe such components are intended to correspond, unless otherwise indicated, to any component which performs the specified function of the described component (e.g., that is functionally equivalent), even though not structurally equivalent to the disclosed structure which performs the function in the illustrated examples or claims. In addition, while a particular feature of the disclosure may have been disclosed with respect to only one of several implementations, such feature may be combined with one or more other features of the other implementations or examples as may be desired and advantageous for any given or particular application.

### REFERENCES

US Patent Documents, hereby incorporated by reference with the present written specification.

Patent publication number: US 2010/0223119 A1
Filing Date: Feb. 2, 2009
Publication Date: Sep. 2, 2010
Title: Advertising through product endorsements in social networks
Inventor: Aaron J. Klish
Current U.S. Classification: 705/14.26

Patent publication number: US 2012/0150592 A1
Filing Date: Nov. 23, 2011
Publication date: Jun. 14, 2012
Title: System and methods for user marketing and endorsement on social networks
Inventor: Endre Govrik, Christopher Govrik, Kirk Larson, Michael Larson
Current U.S. Classification: 705/14.1; 705/14.66

Patent publication number: US 2013/0346171 A1
Filing Date: Jun. 24, 2012
Publication Date: Dec. 26, 2013
Title: Incentivized communications within social networks
Inventor: Jay W. Wright
Current U.S. Classification: 705/14.16

Patent number: U.S. Pat. No. 8,504,559 B1
Filing Date: Jul. 11, 2005
Issue Date: Aug. 6, 2013
Title: Method and system for leveraging the power of one's social-network in an online marketplace
Inventor: Josh Elman, Allen Blue, James Duncan Work, Eric Ly
Current U.S. Classification: 707/722; 705/321

Patent number: U.S. Pat. No. 8,527,344 B2
Filing Date: Nov. 15, 2010
Issue Date: Sep. 3, 2013
Title: Crowdsourced advertisements sponsored by advertisements sponsored by advertisers in a social network environment
Inventor: Brian Rosenthal
Current U.S. Classification: 705/14.49; 705/14.72

Although the invention has been described with reference to the above examples, it will be understood that modifications and variations are encompassed within the spirit and scope of the invention. Accordingly, the invention is limited only by the following claims.

What is claimed is:

1. A computer implemented method for a third party Advertiser to create an Automated Promotional Message (APM), arising from transactional data residing in a computer system, and matching the event to a promotional template, available as an input to a computer system to automatically distribute via Social Influencers in online social networks.

2. The method of claim 1 wherein an event recorded in a computer system can be automatically matched to a promotional Message template.

3. The method of claim 1 wherein the request input provision of a promotional Message by a third party Advertiser to an automated system to distribute the Message through Social Influencers in online social networks can be crafted manually and be input through an internet enabled web browser or through an Application Programming Interface.

4. The method of claim 1 wherein the request input provision of a promotional Message by a third party Advertiser to an automated system to distribute the Message through Social Influencers in online social networks can be from an Automated Promotional Message input through an internet enabled web browser or through an Application Programming Interface.

5. 2. A computer implemented method for an Advertiser to provide a promotional Message, either manually crafted or in the form of an Automated Promotional Message, as an input to a computer system, and for that system without any necessary further input or approval from the Advertiser, to identify and initiate appropriate Social Influencers in online social networks to share the promotional Message online.

6. The method of claim 2 wherein a computer system can receive a request for a promotional Message of an Advertiser to be distributed via Social Influencers in online social networks.

7. The method of claim 2 wherein the computer implemented method is able to identify and match appropriate Social Influencers in online social networks to distribute an Advertiser's promotional Message, without necessarily having the Advertiser have knowledge of, or approve of, the computer selected Social Influencers.

8. The method of claim 2 wherein the computer implemented method actions the approval of promoting the Message with the computer identified Social Influencers. The approval by the Social Influencer to promote the Message can be manual through an internet enabled web browser or can be automated by the computer system with prior approval of the Social Influencers.

9. The method of claim 2 wherein the computer implemented method upon approval of promoting the Message by the computer identified Social Influencers, places (“posts”) the Message into the social networks as an automated process on behalf of the Social Influencers through an Application Programming Interface.

10. The method of claim 2 wherein the computer implemented method upon approval and posting of the promotional Message into the social networks, transfers funds from the Advertiser to the Social Influencers and provides to the Advertiser a report on the application of funds as to which Social Influencers were paid and the activity performance of each Social Influencer for the promotional Message.
